(19) United States
(12) Patent Application Publication
(10) Pub. No.: US 2026/0080171 A1
(43) Pub. Date: Mar. 19, 2026

(54) RETRIEVAL ENHANCEMENT WITH DUAL ADAPTER BASED EMBEDDING

(71) Applicant: QUALCOMM Incorporated, San Diego, CA (US)

(72) Inventors: Seunghan YANG, Incheon (KR); Kyuhong SHIM, Seoul (KR); Jihwan BANG, Seoul (KR); Juntae LEE, Seoul (KR); Minsoo KIM, Seoul (KR); Simyung CHANG, Suwon (KR)

(21) Appl. No.: 18/890,406

(22) Filed: Sep. 19, 2024

(51) Int. Cl. G06F 40/289

(52) U.S. Cl. CPC G06F 40/289

(57) ABSTRACT

Systems and techniques are provided for retrieving data. For example, a method can include obtaining, using a question adapted embedding model, a question, the question adapted embedding model being configured to embed one or more questions into an embedding space, generating, using the question adapted embedding model, a question embedding based on the question, determining, from an embedding space comprising a plurality of chunk embeddings, one or more chunk embeddings associated with the question embedding, and retrieving one or more chunks associated with the one or more chunk embeddings. The plurality of chunk embeddings can be generated by a document adapted embedding model.

### FIELD

The present disclosure is related to retrieval aided generation. In some examples, aspects of the present disclosure are related to systems and techniques for enhancing retrieval with dual adapter-based embedding.

### BACKGROUND

Machine-learning (ML) models (e.g., deep neural networks, such as large language models (LLMs), convolutional neural networks, transformers, diffusion models, etc.) are trained to provide an inference or prediction based on input data. For example, deep neural networks (e.g., LLMs, etc.) can be pre-trained on large datasets to generalize to a wide range of tasks. Applications of deep neural networks include optical flow estimation, text summarization, text generation, sentiment analysis, content creation such as performing generative operations, chatbots, virtual assistants, and conversational artificial intelligence, named entity recognition, speech recognition and synthesis, image annotation, text-to-speech synthesis, spelling correction, machine translation, recommendation systems, fraud detection, accomplishing tasks and code generation.

In some cases, many ML models, such as the aforementioned LLMs, may be implemented using neural networks and/or deep learning networks using a transformer architecture. In some cases, transformer-based ML models may include feed-forward blocks along with other ML blocks. A transformer-based ML model may use an encoder to tokenize inputs, a number of layers to learn relationships between the tokens, and then a decoder to generate predictions using the tokens.

### SUMMARY

In some examples, systems and techniques are described for enhancing data retrieval. According to at least one illustrative example, a method for retrieving data is provided. The method includes: obtaining, using a question adapted embedding model, a question, the question adapted embedding model being configured to embed one or more questions into an embedding space; generating, using the question adapted embedding model, a question embedding based on the question; determining, from an embedding space comprising a plurality of chunk embeddings, one or more chunk embeddings associated with the question embedding, wherein the plurality of chunk embeddings are generated by a document adapted embedding model; and retrieving one or more chunks associated with the one or more chunk embeddings.

In another example, an apparatus for retrieving data is provided that includes a memory and one or more processors (e.g., implemented in circuitry) coupled to the memory. The one or more processors are configured to and can: obtain, using a question adapted embedding model, a question, the question adapted embedding model being configured to embed one or more questions into an embedding space; generate, using the question adapted embedding model, a question embedding based on the question; determine, from an embedding space comprising a plurality of chunk embeddings, one or more chunk embeddings associated with the question embedding, wherein the plurality of chunk embeddings are generated by a document adapted embedding model; and retrieve one or more chunks associated with the one or more chunk embeddings.

In another example, a non-transitory computer-readable medium is provided that has stored thereon instructions that, when executed by one or more processors, cause the one or more processors to: obtain, using a question adapted embedding model, a question, the question adapted embedding model being configured to embed one or more questions into an embedding space; generate, using the question adapted embedding model, a question embedding based on the question; determine, from an embedding space comprising a plurality of chunk embeddings, one or more chunk embeddings associated with the question embedding, wherein the plurality of chunk embeddings are generated by a document adapted embedding model; and retrieve one or more chunks associated with the one or more chunk embeddings.

In accordance with another embodiment of the present disclosure, an apparatus for retrieving data is provided. The apparatus includes: means for obtaining, using a question adapted embedding model, a question, the question adapted embedding model being configured to embed one or more questions into an embedding space; means for generating, using the question adapted embedding model, a question embedding based on the question; means for determining, from an embedding space comprising a plurality of chunk embeddings, one or more chunk embeddings associated with the question embedding, wherein the plurality of chunk embeddings are generated by a document adapted embedding model; and means for retrieving one or more chunks associated with the one or more chunk embeddings.

In some aspects, one or more of the apparatuses described above is, is part of, or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram of an example transformer, in accordance with some examples of the present disclosure;

FIG. 2 is a block diagram illustrating a retrieval aided generation (RAG) system, in accordance with some examples of the present disclosure;

FIG. 3A is a block diagram illustrating an example offline data pre-processing configuration for a RAG system, in accordance with some examples of the present disclosure;

FIG. 3B is a block diagram illustrating an example training process for the QA adapted embedding model, in accordance with some examples of the present disclosure;

FIG. 3C is a block diagram illustrating an example retrieval configuration for a RAG system, in accordance with some examples of the present disclosure;

FIG. 4A is a block diagram illustrating an additional example offline data pre-processing configuration for a RAG system, in accordance with some examples of the present disclosure;

FIG. 4B is a block diagram illustrating an additional example retrieval configuration for a RAG system, in accordance with some examples of the present disclosure;

FIG. 4C is a block diagram illustrating an example training process for a document adapted embedding model and a question adapted embedding model, in accordance with some examples of the present disclosure;

FIG. 5 is a block diagram illustrating an example adapted embedding model configuration that may be utilized for adapting an embedding model, in accordance with some examples of the present disclosure;

FIG. 6A is a block diagram illustrating an example contrastive learning configuration that may be utilized for contrastive training of the QA adapted embedding model of FIG. 3A through FIG. 3C, in accordance with some examples of the present disclosure;

FIG. 6B is a diagram illustrating relationships between chunks and questions generated based on chunks, in accordance with some examples of the present disclosure;

FIG. 6C is a block diagram illustrating an example contrastive learning configuration that may be utilized for contrastive training of the document adapted embedding model of FIG. 4A and the question adapted embedding model of FIG. 4B, in accordance with some examples of the present disclosure;

FIG. 7 is a flow diagram illustrating an example of a process for enhancing retrieval, in accordance with some examples of the present disclosure;

FIG. 8 is a block diagram illustrating an example of a deep learning network, in accordance with some examples of the present disclosure;

FIG. 9 is a block diagram illustrating an example of a convolutional neural network, in accordance with some examples of the present disclosure;

FIG. 10 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, audio processing, and image processing, among other tasks. Moreover, machine learning models can be versatile and can achieve high quality results in a variety of tasks.

Different types of neural networks exist, such as deep generative neural network models (e.g., generative pre-trained transformers (GPTs) generative adversarial network (GANs)), recurrent neural network (RNN) models, multilayer perceptron (MLP) neural network models, convolutional neural network (CNN) models, among others.

Generative machine-learning models (e.g., generative neural networks) can be used to generate synthesized outputs (e.g., images with synthesized objects, backgrounds, etc.). An example of a generative machine-learning model is a diffusion neural network model. In some cases, generative machine-learning models can be used for large language model (LLMs) or large vision models (LVMs), among others.

In some cases, LLMs can be utilized for natural language processing (NLP), which can include natural language understanding (NLU) and/or natural language generation (NLG). NLU refers to understanding the meaning of written and/or spoken language (e.g., text, speech, or a combination thereof). Examples of the NLU include text inference or email classification. NLG refers to the task of producing written and/or spoken language (e.g., text, speech, or a combination thereof) from structured data, unstructured data, or a combination thereof. Examples of NLG include query-focused summarization, story generation, news summarization, conversational artificial intelligence (AI), an auto-complete system or combinations thereof. In some examples, NLP systems may include a combination of NLU and NLG, such as question answering, interpreting and then summarizing content (e.g., a news article or a story), or a combination thereof. In some examples, NLG can include transformer-based NLG.

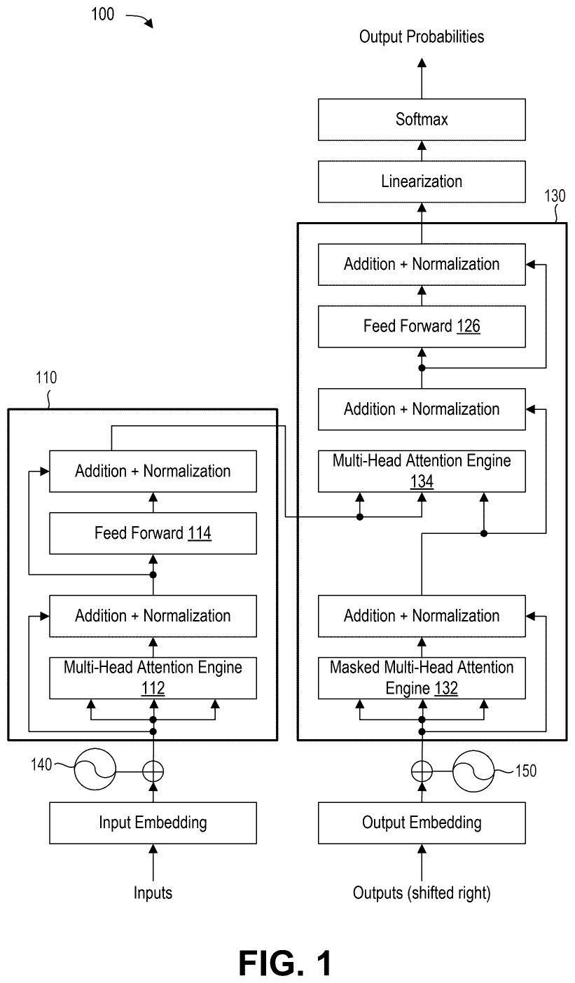

A transformer (e.g., transformer 100 of FIG. 1) can be utilized as a generative model (e.g., for performing generative tasks) and/or as a non-generative model (e.g., a discriminative model). In general, a transformer is a deep learning model. A transformer typically performs self-attention (e.g., using at least one self-attention layer), differentially weighting the significance of each part of input (which includes the recursive output) data. Transformers can be used in many contexts, including the fields of natural language processing (NLP), image processing, audio processing, or the like. Like recurrent neural networks (RNNs), transformers are designed to process sequential input data, such as natural language, with application to tasks such as translation and text summarization. However, unlike RNNs, transformers process the entire input all at once. The attention mechanism provides context for any position in the input sequence. For example, if the input data is a natural language sentence, the transformer does not have to process one word at a time. This allows for more parallelization than RNNs and therefore reduces training times. Compared to RNN models, transformers are more amenable to parallelization, allowing training on larger datasets.

In some cases, NLG models can generate text that includes hallucinations, or instances where the NLG models become convinced of untrue facts and generate text or speech based on the untrue facts. For instance, an NLG model may hallucinate while attempting to summarize a news article about a car accident involving multiple people by incorrectly stating, in the output text, that someone died in the accident who did not in fact die in the accident. An NLG model may hallucinate captions for audio signals in which a described feature of the audio signal is not actually contained in the audio signal.

Similar to NLG models, multimodal models or unimodal models can also hallucinate while attempting to generate output text. Multi-model models and in some cases unimodal models can process one or more different modes or types of input and generate output text describing or associated with the input data.

Generative machine-learning models can require a large amount of processing and memory resources. For example, memory input/output (I/O) operations can be a critical bottleneck in on-device learning/training of generative machine-learning models. To address such complexity of generative machine-learning model, techniques may be performed to minimize the number of parameters (e.g., weights, activations, biases, etc.) of the model that are updated, to reduce the number of training steps required for finetuning of the model parameters, and/or to adapt the model using an adaptor.

Retrieval augmented generation (RAG) can be utilized to extend knowledge, personalize, and/or prevent hallucination for LLM systems. In RAG based LLM systems, additional retrieval models can be used in conjunction with an LLM to provide task-specific fine-tuning applied to target documents. In one illustrative example, a retrieval model can be trained to answer questions about a particular vehicle make and/or model. In some cases, building a retrieval model includes dividing a document into parts (hereinafter referred to as “chunks”) and generating questions based on the chunks. In some cases, the retrieval model can be trained to output one or more relevant chunks based on an input question in a supervised learning process. In some cases, the retrieval modern can extra sentence embeddings for the questions and sentence embeddings for the chunks. In some cases, a contrastive learning technique can be applied to bring related chunks and/or questions close together in the embedding space.

However, utilized the same model to embed both questions and models can result in a discrepancy between related question embeddings and chunk embeddings in an embedding space. For example, for the question “what is your name?” and the chunk used to generate the question, “my name is Bob,” the difference in sentence format is expected to result in embeddings with a relatively large discrepancy. However, for precise matching, the question and corresponding chunk used to generate the question (hereinafter referred to as a “positive pair”) should be located closely (e.g., having a high cosine similarity) in the embedding space. In some cases, contrastive learning can be utilized to draw positive pairs closer together in the embedding space and push negative pairs in the question space apart. Some contrastive learning techniques further include pushing negative pairs apart in the embedding space. In some cases, a negative pair can include a particular chunk and any question other than the question generated based on the particular chunk. In some examples, a negative pair can include a particular question and any chunk other than the chunk used to generate the particular question. In some aspects, questions and/or chunks that are considered negative pairs may nevertheless have similarities (also referred to herein as “positive elements”). However, by pushing negative pairs apart using contrastive learning, the opposite effect may be achieved.

Systems and techniques are needed for generating embeddings for chunks and corresponding questions that allow for negative pairs with positive elements to be organized close together in an embedding space. Systems and techniques are described herein for enhancing retrieval with dual adapter embedding. In some cases, a retrieval model trained on a general data set can be utilized as a base model for question embedding and chunk embedding. In some cases, a chunk adapter can be added to a retrieval model and can be utilized to embed only the chunks extracted from a document. In some examples, a question adapter can be added to the retrieval model and can be utilized to embed only the questions generated based on the chunks. In some cases, by providing a question adapter and a separate chunk adapter, discrepancies between question and chunk embeddings can be reduced during the training process. For example, a masked contrastive learning process can be utilized to allow negative pairs that contain positive elements to be drawn together, rather than being pushed apart.

Various aspects of the techniques described herein will be discussed below with respect to the figures.

In a CNN model, the number of operations required to relate signals from two arbitrary input or output positions grows with the distance between positions, which makes learning dependencies at different distant positions challenging for a CNN model. A transformer 100 reduces the operations of learning dependencies by using an encoder 110 and a decoder 130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key. In one example of a transformer, the encoder 110 is composed of a stack of six identical layers and each layer has two sub-layers. The first sub-layer is a multi-head self-attention engine 112, and the second sub-layer is a fully connected feed-forward network 114. A residual connection (not shown) connects around each of the sub-layers followed by normalization.

In this example transformer 100, the decoder 130 is also composed of a stack of six 6 identical layers. The decoder also includes a masked multi-head self-attention engine 132, a multi-head attention engine 134 over the output of the encoder 110, and a fully connected feed-forward network 126. Each layer includes a residual connection (not shown) around the layer, which is followed by layer normalization. The masked multi-head self-attention engine 132 is masked to prevent positions from attending to subsequent positions and ensures that the predictions at position i can depend only on the known outputs at positions less than i (e.g., auto-regression), where i is a position index.

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 140 to encode positions because the model does not contain recurrence and convolution and relative or absolute position of the tokens is needed. In the transformer 100, the positional encodings are added to the input embeddings at the bottom layer of the encoder 110 and the decoder 130. The positional encodings are summed with the embeddings because the positional encodings and embeddings have the same dimensions. A corresponding position decoder 150 is configured to decode the positions of the embeddings for the decoder 130.

In some aspects, the transformer 100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 100 can process input sequences of variable length, making it well-suited for natural language processing tasks where input lengths can vary greatly. Additionally, the self-attention mechanism allows the transformer 100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

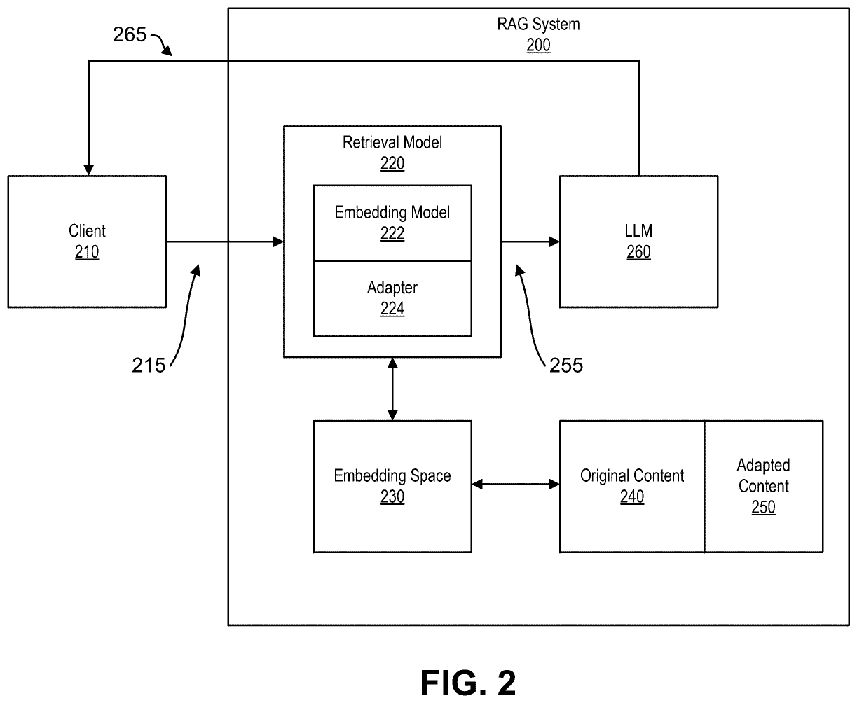

FIG. 2 is a block diagram illustrating a RAG system 200. As noted above, the RAG system 200 can be utilized to extend knowledge, personalize, and/or prevent hallucination for LLM systems. In some cases, the RAG system be used to augment and/or update an LLM system without the need to complete retrain the LLM system itself. In RAG based LLM systems, one or more additional retrieval models (e.g., retrieval model 220) can be used in conjunction with an LLM to provide task-specific fine-tuning applied to target documents. In the example of FIG. 2, the RAG system 200 includes a retrieval model 220, an embedding space 230, and an LLM 260.

In some examples, the RAG system 200 can be and/or can be included in a mobile device or handset (e.g., a mobile telephone or so-called “smart phone” or other mobile device), a wearable device (e.g., a HMD, smart glasses), a wireless communication device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

As shown in FIG. 2, a client 210 may provide a query to a retrieval model 220. In some cases, the retrieval model 220 can retrieve chunks (e.g., sentences, paragraphs, sections, or the like) of data relevant to the question from the embedding space 230. In one illustrative example, the embedding space 230 may include a vectorDB embedding space. However, it should be understood that any other suitable embedding space may be utilized without departing from the scope of the present disclosure. As illustrated, the embedding space may include embeddings for original content 240 and embeddings for adapted content 250. In some examples, the original content 240 may be data provided to initially train an embedding model included in the retrieval model 220. In some implementations, the embeddings for adapted content 250 may include content relevant to a particular domain or data source for which the embedding model 222 is supplemented by fine-tuning. For example, as illustrated in FIG. 2, the embedding model 222 may be supplemented by an adapter 224. In some examples, the embedding model 222 may be supplemented by prefix training, adapter tuning, low-rank adaptation (LoRA) tuning, and or any other suitable fine-tuning techniques.

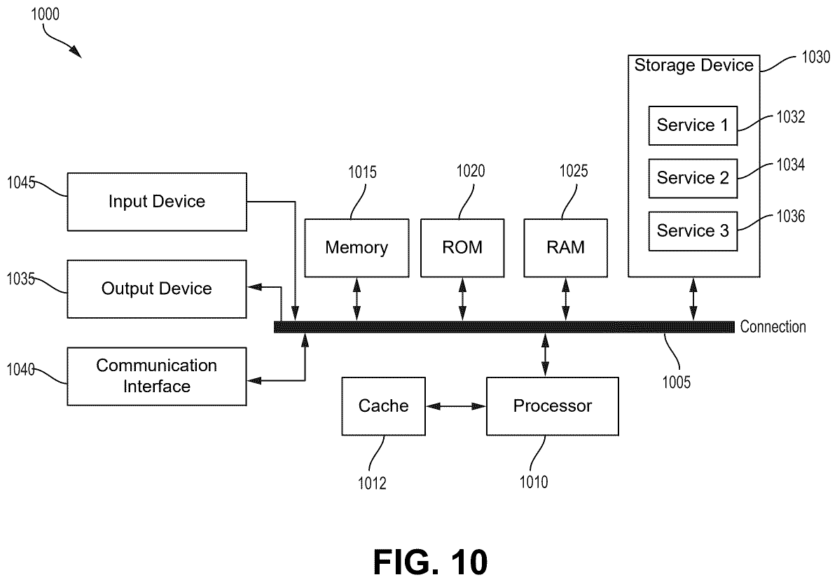

In some cases, the retrieval model 220 may process the question obtained from the client 210 to generate an embedding for the question. In some examples, the retrieval model 220 may retrieve a number of chunks (e.g., K number of chunks, where K is an integer) that correspond to the query 215. For example, the retrieval model 220 may retrieve the K number of chunks with chunk embeddings having the highest similarity (e.g., cosine similarity) to the embedding of the query 215 within the embedding space. In some cases, indices of the top-K similar chunk embeddings to the question embedding may be used to retrieve the chunks from original content 240 and/or adapted content 250. In some cases, the original content 240 and/or the adapted content 250 may be stored in data storage (e.g., in cache 1012, memory 1015, ROM 1020, RAM 1025, storage device 1030 of FIG. 10).

In some cases, the RAG system 200 may perform additional post-retrieval processing (not shown) of the K chunks to select the most relevant chunks, remove excluded chunks, or the like. In some cases, the post retrieval processing (not shown) can select the top M number of chunks where M≤K. In some cases, the RAG system 200 may combine the original question from the client 210 with the top M chunks retrieved by the retrieval model 220 to generate a retrieval augmented prompt 255 for the LLM 260. In some examples, the LLM 260 may output a response 265 based on the retrieval augmented prompt 255 to the client 210.

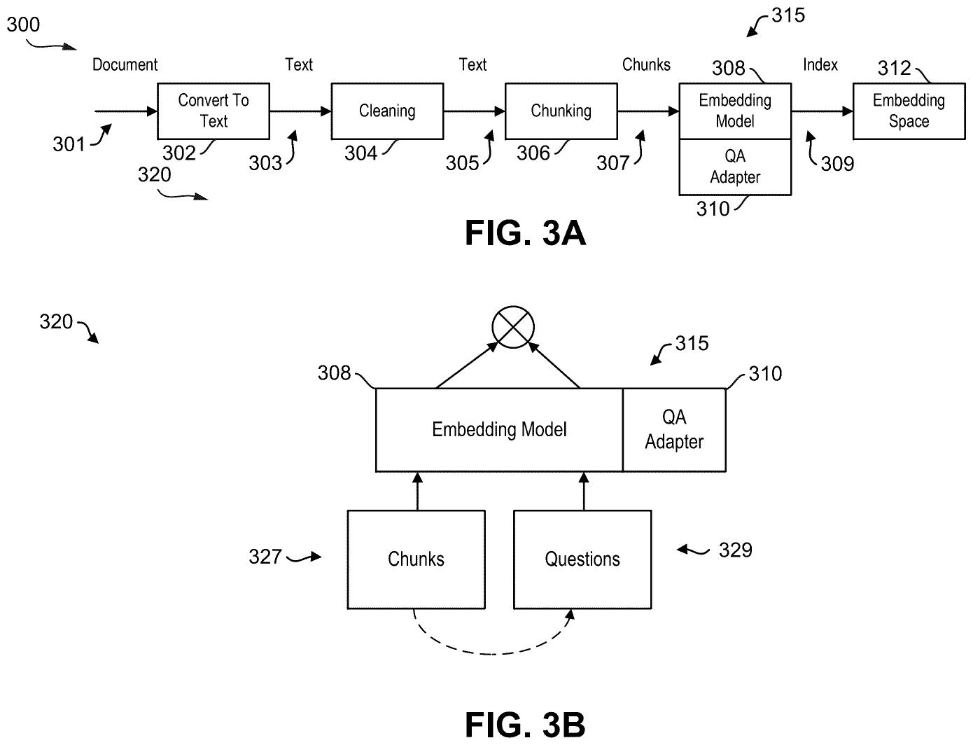

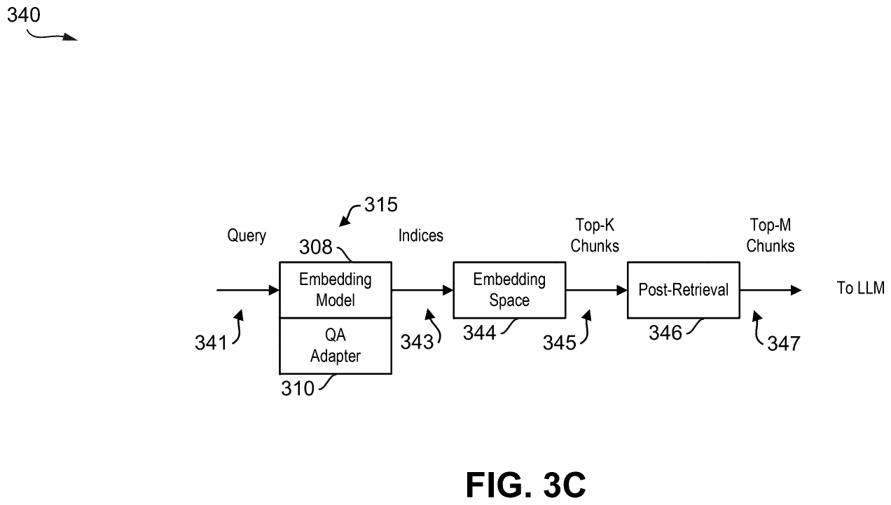

FIG. 3A is a block diagram 300 illustrating an example offline data pre-processing configuration for a RAG system (e.g., RAG system 200 of FIG. 2). As shown in FIG. 3A, a document 301 may be input into a text conversion module 302. In some aspects, the text conversion module 302 may perform text recognition on the content of the document 301. For example, the text conversion module 302 may perform optical character recognition (OCR) to recognize and extract text from the document 301. As illustrated in FIG. 3A, an output of the text conversion module 302 may include converted text 303 which is input into a cleaning module 304. In some cases, the cleaning module 304 may be configured to refine a text conversion process to ensure the resulting output is easily read. For example, the cleaning module 304 may be configured to fix issues with formatting that may arise from converting a document between different formats (e.g., text extracted from a portable document format (PDF)). In one some examples, functions of the cleaning module 304 may include, without limitation, fixing layout errors, fixing formatting errors, fixing word separation errors (e.g., due to hyphens and/or line breaks), fixing issues with special characters and/or symbols, removing duplicate and/or unnecessary whitespace, removing table of contents, removing page numbers, removing image titles and/or descriptions, and/or any combination thereof.

As illustrated in FIG. 3A, cleaned text 305 output by the cleaning module 304 may be input into a chunking module 306. In some implementations, the chunking module 306 may be configured to break down the text extracted from the document into smaller segments. In some implementations, chunks may be segmented from the cleaned text 305 according to specific rules. For example, chunks may be segmented based on paragraphs, sections, images, tables, markdown, or the like.

As shown in FIG. 3A, chunks 307 output by the chunking module 306 may be input to an embedding model 308. In some cases, the embedding model 308 can be trained extract an embedding for a chunk of text. In some examples, the extracted embedding can be associated with an index within the embedding space 312 that may be used to identify the extracted embedding. In some implementations, embeddings may be compared using a similarity function (e.g., cosine similarity) and relevant chunks may be identified based on the similarity function. As shown in FIG. 3A, a question and answer (QA) adapter 310 may be applied to the embedding model 308. For the purposes of simplicity, the embedding model as adapted by the QA adapter 310 will hereinafter be referred to as the QA adapted embedding model 315. In some cases, during inference, the embeddings for the chunks of text extracted from the document 301 can be stored in the embedding space 312 with corresponding indices 309.

In some aspects, the embedding model 308 may be trained to generate text embeddings utilizing a generalized training dataset (e.g., questions and answers). In some cases, the QA adapter 310 may be utilized to fine-tune the performance of the embedding model 308 when applied to target documents. In some examples, the target documents may be associated with a particular task. In one illustrative example, the target documents may include a vehicle owners' manual. In such an example, the particular task associated with the target documents may include retrieving relevant text from the embedding space 312 (e.g., embeddings for the target documents) based on input questions.

FIG. 3B is a block diagram 320 illustrating an example training process for the QA adapted embedding model 315 of FIG. 3A. In some implementations, the embedding model 308 can be a pre-trained model trained on one or more large-scale datasets with chunk embeddings (e.g., sentence embeddings). In some examples, the training process for training the QA adapted embedding model 315 may include training of the QA adapter 310 while maintaining the weights of the pre-trained embedding model 308 with static values. In some cases, a training dataset may be generated based on one or more target documents for a specific task for which fine-tuning of the performance of the QA adapted embedding model 315 is desired. In some implementations, the one or more target documents may be converted (e.g., by chunking module 306 of FIG. 3A) into chunks 327 according to a specified chunking rule set. In some cases, questions 329 can be generated from the chunks 327 by referencing a specific chunk or several chunks. For example, without limitation, the questions 329 can be generated from the chunks 327 by a LLM (e.g., GPT, Mistral), human input, and/or any combination thereof. In some implementations, a chunk (or several chunks). In some implementations, a chunk 327 and the associated question 329 generated from the chunk can be considered a positive pair. In some cases, a question may be generated based on several chunks that are combined (e.g., concatenated). In some examples, if multiple different chunks 327 generate an identical question 329, each chunk that generated the question may be considered a positive pair with the question. For example, a single question 329 may be included in a positive pair with a first chunk 327 while simultaneously being included in a positive pair with a second chunk 327 different from the first chunk. In some aspects, a chunk 327 and any question 329 not generated from the chunk 327 may be considered a negative pair. In some cases, the QA adapted embedding model 315 may generate embeddings for the chunks 327 and the questions 329. In some cases, a contrastive learning process may be applied to the questions 329 and chunks 327.

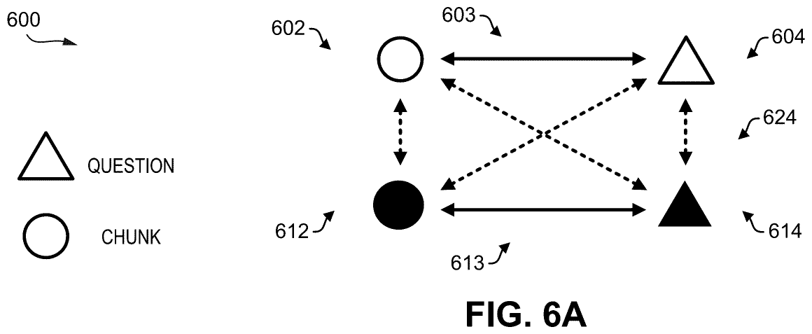

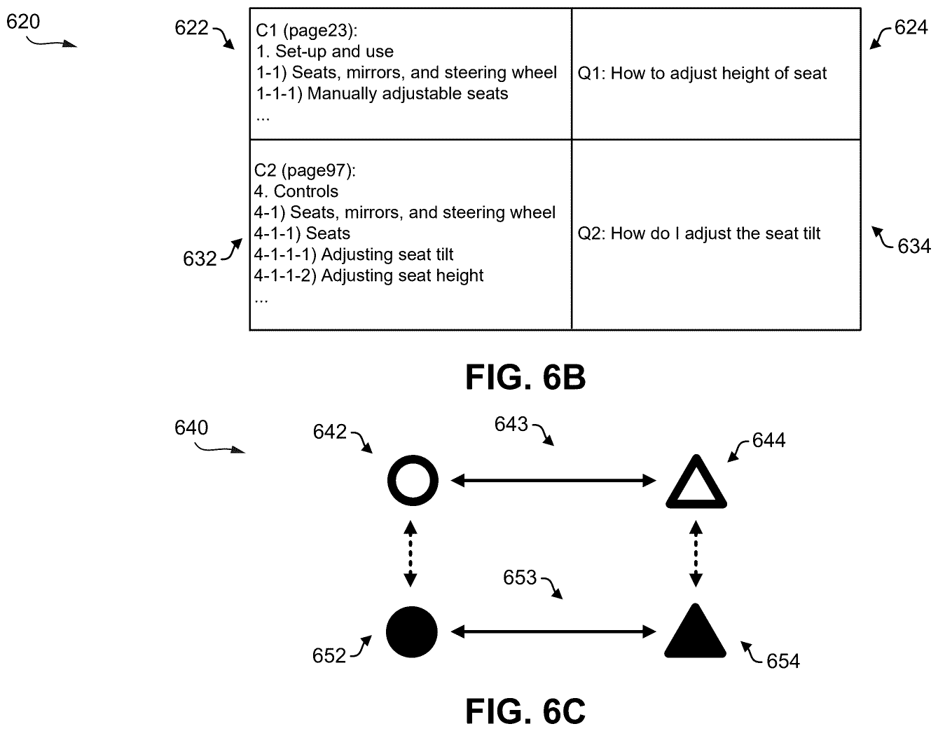

FIG. 6A is a block diagram illustrating an example contrastive learning configuration 600 that may be utilized for contrastive training of the QA adapted embedding model 315 of FIG. 3A, FIG. 3B, and FIG. 3C. In the example of FIG. 6A, a first chunk 602 (e.g., chunks 327 of FIG. 3B) may be used to generate a first question 604 (e.g., questions 329 of FIG. 3B). In some cases, the first question 604 may be generated from the first chunk 602 by an LLM (e.g., GPT, Mistral), human input, and/or any combination thereof. In some cases, a second chunk 612 may be used to generate a second question 614. In some implementations, a chunk and the associated question generated from the chunk may be treated as a positive pair (as indicated by a solid line in FIG. 6A). Accordingly, the first chunk 602 and the first question 604 may be considered a first positive pair 603. Similarly, the second chunk 612 and the second question 614 may be considered a second positive pair 613.

As noted above, in some examples, a chunk and any question not generated from a chunk may be considered a negative pair (as indicated by dashed lines in FIG. 6A). For example, first chunk 602 may be considered a negative pair with second question 614. As another example, second chunk 612 may be considered a negative pair with first question 604. In some cases, each individual chunk may be considered a negative pair with any other chunk. For example, first chunk 602 may be considered a negative pair (as indicated by dashed lines in FIG. 6A) with second chunk 612. In some implementations, each individual question may be considered a negative pair (as indicated by dashed lines in FIG. 6A) with any other question. For example, first question 604 may be considered a negative pair (as indicated by dashed lines in FIG. 6A) with second question 614.

FIG. 6B is a diagram 620 illustrating example chunks and questions. In the illustrated example of FIG. 6B, a first chunk 622 corresponds to a first question 624 generated based on the first chunk 622. Similarly, a second chunk 632 corresponds to a second question 634 generated based on the second chunk 632. In some implementations, the first chunk 622 and the first question 624 can be considered a first positive pair. Similarly, the second chunk 632 and the second question 634 can be considered a second positive pair. In some cases, (e.g., using the contrastive learning configuration 600 of FIG. 6A), the first chunk 622 and the second question 634 can be considered to be in a negative pair. Similarly, in some examples, the second chunk 632 and the first question 624 can be considered to be in a negative pair. However, as illustrated in FIG. 6B, the first question 624 includes the text “how to adjust height of seat” and the second question 634 includes the text “how to adjust seat tilt.” In some aspects, the content of the first question 624 and the second question 634 may be considered to be related such that embeddings of the first question 624 and the second question 634 would preferably be similar to one another. However, assigning negative pairs to chunks and any question other than the question generated based on a chunk may result in the first question 624 and the second question 634 being pushed apart during the training process.

Returning to FIG. 3B, QA adapted embedding model 315 may generate embeddings for the chunks (e.g., chunk 602, chunk 612) and the questions (e.g., question 604, question 614). In some examples, the training process for the QA adapted embedding model 315 may include applying a contrastive learning loss function to draw together positive pairs (e.g., positive pairs 603, 613 of FIG. 6A) and to push negative pairs apart within an embedding space (e.g., a vector database or VectorDB). An example training loss function L_{QA} for the training process for the QA adapted embedding model 315 is illustrated in Equation (1) below:

$${L}_{QA} = - {\sum }_{i ∈ I} log \frac{exp ( {z}_{i} * {z}_{j ( i )} )}{{\sum }_{a ∈ A ( i )} exp ( {z}_{i} * {z}_{a} )} \qquad ( 1 )$$

Where i is an index representing each positive pair, I is an integer representing the number of positive pairs in the training dataset, * represents a cosine similarity function, zᵢ is a question embedding or chunk embedding, zⱼ₍ᵢ₎ is a chunk or question embedding, a is an index, and zₐ represents the question embeddings and/or chunk embeddings in negative pairs with the ith chunk or question zᵢ. Equation (2) and Equation (3) below illustrate represent the sampling of positive pairs and negative pairs, respectively.

$$i ∈ I ≡ \{ 1 , … , N \} \qquad ( 2 )$$

$$A ( i ) ≡ I ∖ \{ i \} ( negative indices ) \qquad ( 3 )$$

In some cases, the weights for the QA adapted embedding model 315 may be obtained by combining the weights of the embedding model 308 and the QA adapter 310 to form a set of adapted weights for the QA adapted embedding model 315. In one illustrative example, the adapted weights for the QA adapted embedding model 315 may be obtained by adding together the weights for the embedding model 308 with finetuned weights for the QA adapter 310. For example, finetuning of the QA adapted embedding model 315 may include keeping the pre-trained weights W∈ [symbol] ^{d×d} for the embedding model 308 static while updating parameters of the QA adapter 310, where W is a matrix containing the weights, [symbol] is the set of real numbers, and d×d represents a dimension of the matrix. In some cases, finetuning of the QA adapted embedding model 315 includes performing a forward pass of the training date through the QA adapted embedding model 315 and performing a backward pass to update parameters (e.g., weights, etc.) of the QA adapter 310. In some aspects, the backward pass may include calculating gradients to minimize a training loss (e.g., training loss function L_{QA} of Equation (1)). In conventional finetuning, all intermediate activations are calculated, layer by layer, and all of the parameter data is saved. In some cases, during the backward pass, the QA adapter 310 can update the parameters across all the layers during backpropagation. However, in some examples, the number of parameters may be reduced by representing the parameters across all layers of the QA adapter 310 using a more compact representation, thereby reducing the total size of the QA adapter 310. In one illustrative example, the parameters of the QA adapter 310 can be represented as low rank matrices using a low-rank adaptation (LoRA) machine learning model for the QA adapter 310.

FIG. 3C is a block diagram 340 illustrating an example retrieval configuration for a RAG system (e.g., RAG system 200 of FIG. 2). In the example of FIG. 3C, a query 341 can be provided to the QA adapted embedding model 315. In some cases, the query 341 may be directly provided by a client (e.g., a user) to the QA adapted embedding model 315. In some cases, a pre-processing module (not shown) may process the query 341 before passing the query to the QA adapted embedding model 315. For example, if the query 341 (or a chunk) is long, the pre-processing module (not shown) may truncate the query 341 (or chunk) prior to providing the query (or chunk) to the QA adapted embedding model 315. In some aspects, the pre-processing module (not shown) may perform tokenization on the query 341 (or chunk) to prepare the question (or chunk) as an input to the QA adapted embedding model 315. In some examples, the QA adapted embedding model 315 may generate an embedding 343 for the question (e.g., query 341).

In some implementations, during inference, the QA adapted embedding model 315 for embedding question (e.g., query 341) may be identical to the QA adapted embedding model 315 of FIG. 3A. In some examples, the parameters (e.g., weights) of the embedding model 308 may be identical when used for embedding chunks and for embedding questions (e.g., query 341). In some implementations, the parameters (e.g., weights) of the QA adapter 310 may be identical when used for embedding chunks and for embedding questions (e.g., query 341).

In some cases, the RAG system (e.g., RAG system 200 of FIG. 2) may identify the top-K chunk embeddings within the embedding space 344 based on a comparison between the embedding of the question (e.g., query 341) and the embeddings of chunks stored in the embedding space 344 (e.g., as shown in block diagram 300 of FIG. 3A), where K is an integer. In some examples, the embedding space 344 may output the top-K chunks 345 to a post-retrieval module 346. In some cases, the post-retrieval module 346 may process the top-K chunks 345. For example, the post-retrieval module 346 may correct formatting, remove redundancies, and/or perform any other post-processing on the top-K chunks 345. In some cases, the post-retrieval module 346 may output the top-M chunks 347, where M is an integer, to an LLM. In some examples, the top-M chunks may be appended to an original query (e.g., query 341, to generate an augmented query.

In some examples, by embedding both chunks and questions using a single adapter (e.g., QA adapted embedding model 315 of FIG. 3A through FIG. 3C), structural limitations may interfere with adapter performance. For example, the QA adapter 310 may be represented by a function ƒ(x). In one illustrative example, a chunk x₀ and a question x₁ may be included in a positive pair. In some examples, due to the fact that the QA adapted embedding model 315 is used for embedding both chunks and question, only a single function ƒ(x) will be used to embed the chunk x₀ and the question x₁. In some cases, it may be desirable for ƒ(x₀)≈ƒ(x₁)≈y₀ such that the chunk x₀ may produce an identical (or nearly identical) output. However, if the function ƒ(x) produces the same output for two different inputs, the QA adapted embedding model 315 may not be able to produce outputs that are sufficiently different based on different inputs to perform the desired fine-tuned embedding of the QA adapted embedding model 315.

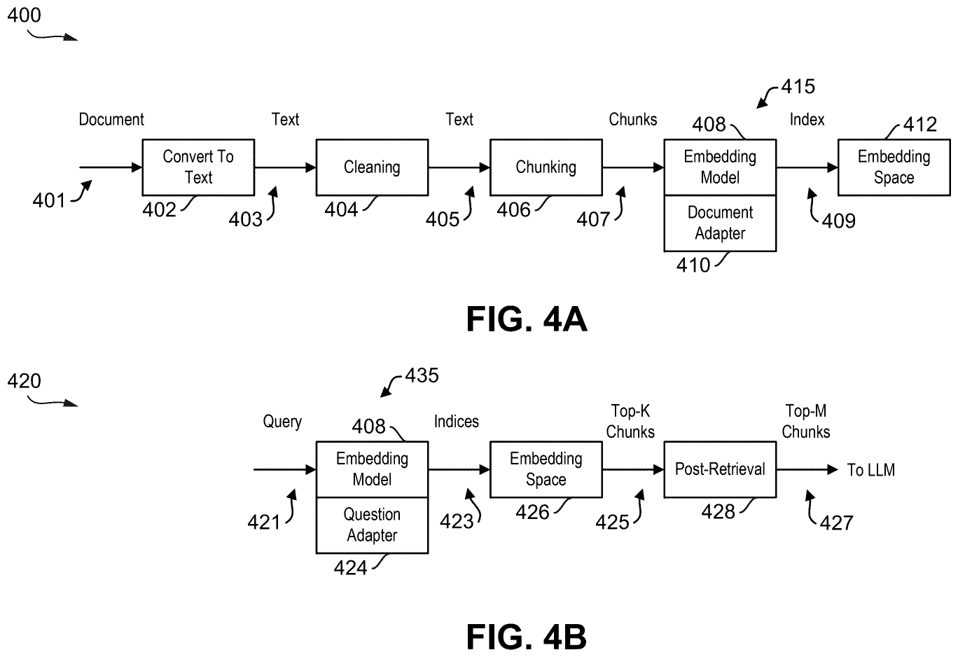

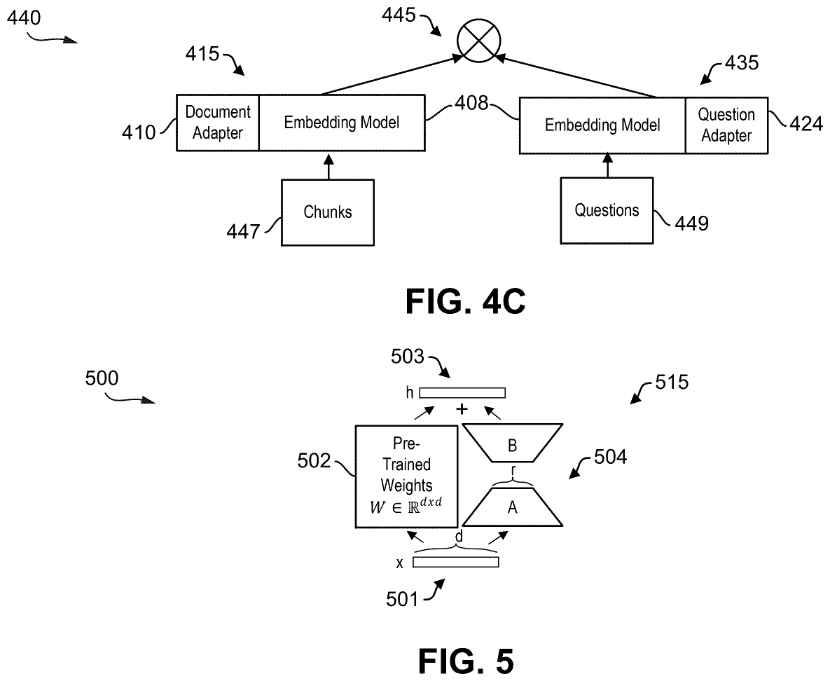

FIG. 4A is a block diagram 400 illustrating an additional example offline data pre-processing configuration for a RAG system (e.g., RAG system 200 of FIG. 2). As shown in FIG. 4A, a document 401 may be input into a text conversion module 402. In some aspects, the text conversion module 402 may perform text recognition on the content of the document 401. For example, the text conversion module 402 may perform optical character recognition (OCR) to recognize and extract text from the document 401. As illustrated in FIG. 4A, an output of the text conversion module 402 may include converted text 403 which is input into a cleaning module 404. In some cases, the cleaning module 404 may be configured to refine a text conversion process to ensure the resulting output is easily read. For example, the cleaning module 404 may be configured fix issues with formatting that may arise from converting a document between different formats (e.g., text extracted from a portable document format (PDF)). In some examples, functions of the cleaning module 304 may include, without limitation, fixing layout errors, fixing formatting errors, fixing word separation errors (e.g., due to hyphens and/or line breaks), fixing issues with special characters and/or symbols, removing duplicate and/or unnecessary whitespace, removing table of contents, removing page numbers, removing image titles and/or descriptions, and/or any combination thereof.

As illustrated in FIG. 4A, cleaned text 405 output by the cleaning module 404 may be input into a chunking module 406. In some implementations, the chunking module 406 may be configured to break down the text extracted from the document into smaller segments. In some implementations, chunks may be segmented from the cleaned text 405 according to specific rules. For example, chunks may be segmented based on paragraphs, sections, images, tables, markdown, or the like.

As shown in FIG. 4A, chunks 407 output by the chunking module 406 may be input to an embedding model 408. In some cases, the embedding model 408 can be trained extract an embedding for a chunk of text. In some examples, the extracted embedding can be associated with an index 409 within the embedding space 412. In some implementations, embeddings may be compared using a similarity function (e.g., cosine similarity) and relevant chunks may be identified based on the similarity function. As shown in FIG. 4A, a document adapter 410 may be applied to the embedding model 408. For the purposes of simplicity, the embedding model as adapted by the document adapter 410 will hereinafter be referred to as the document adapted embedding model 415. In some cases, during inference, the embeddings for the chunks of text extracted from the document 301 can be stored in the embedding space 312 with corresponding indices 309.

In some aspects, the embedding model 408 may be trained to generate text embeddings utilizing a generalized training dataset (e.g., questions and answers). In some cases, the document adapter 410 may be utilized to fine-tune the performance of the embedding model 408 when applied to target documents. In some examples, the target documents may be associated with a particular task. In one illustrative example, the target documents may include a vehicle owners' manual. In such an example, the particular task associated with the target documents may include retrieving relevant text from the embedding space 312 (e.g., embeddings for the target documents) based on input questions (e.g., for RAG).

FIG. 4B is a block diagram 420 illustrating an additional example retrieval configuration for a RAG system (e.g., RAG system 200 of FIG. 2). In the example of FIG. 4B, a query 421 can be provided to a question adapted embedding model 435. In some examples, the embedding model 435 may include the embedding model 408 and a question adapter 424.

In some cases, the query 421 may be directly provided by a client (e.g., a user) to the question adapted embedding model 435. In some cases, a pre-processing module (not shown) may process the query 421 before passing the query to the document adapted embedding model 435. For example, if the query 421 (or a chunk) is long, the pre-processing module (not shown) may truncate the query 421 (or chunk) prior to providing the query (or chunk) to the question adapted embedding model 435. In some aspects, the pre-processing module (not shown) may perform tokenization on the query 421 (or chunk) to prepare the question (or chunk) as an input to the question adapted embedding model 435. In some examples, the parameters (e.g., weights) of the embedding model 408 may be identical when used for embedding chunks and for embedding questions (e.g., query 421). However, in some implementations, the parameters (e.g., weights) of the question adapter 424 may be different from the parameters of the document adapter 410 of FIG. 4A. In some examples, the document adapted embedding model 435 may generate an embedding 423 for the question (e.g., query 421).

In some cases, the RAG system (e.g., RAG system 200 of FIG. 2) may identify the top-K chunk embeddings within the embedding space 426 based on a comparison between the embedding of the question (e.g., query 421) and the embeddings of chunks stored in the embedding space 426 (e.g., as shown in block diagram 300 of FIG. 3A), where K is an integer. In some examples, the embedding space 426 may output the top-K chunks 425 to a post-retrieval module 428. In some cases, the post-retrieval module 428 may process the top-K chunks 425. For example, the post-retrieval module 428 may correct formatting, remove redundancies, and/or perform any other post-processing on the top-K chunks 425. In some cases, the post-retrieval module 428 may output the top-M chunks 427, where M is an integer, to an LLM. In some examples, the top-M chunks may be appended to an original query (e.g., query 421, to generate an augmented query.

FIG. 4C is a block diagram 440 illustrating an example training process for document adapted embedding model 415 of FIG. 4A and the question adapted embedding model 435 of FIG. 4B. In some implementations, the embedding model 408 can be a pre-trained model trained on one or more large-scale datasets with chunk embeddings (e.g., sentence embeddings). In some examples, the training process for training the document adapted embedding model 415 of FIG. 4A and the question adapted embedding model 435 of FIG. 4B may include training of the document adapter 410 and the question adapter 424 while maintaining the weights of the pre-trained embedding model 408 with static values. In some cases, a training dataset may be generated based on one or more target documents for a specific task for which fine-tuning of the performance of the document adapted embedding model 415 of FIG. 4A and the question adapted embedding model 435 of FIG. 4B is desired. In some implementations, the one or more target documents may be converted (e.g., by chunking module 406 of FIG. 4A) into chunks 447 according to a specified chunking rule set. In some cases, questions 449 can be generated from the chunks 447 by referencing a specific chunk or several chunks. For example, without limitation, the questions 449 can be generated from the chunks 447 by a LLM (e.g., GPT, Mistral), human input, and/or any combination thereof. In some implementations, a chunk (or several chunks). In some implementations, a chunk 447 and the associated question 449 generated from the chunk can be considered a positive pair. In some cases, a question may be generated based on several chunks that are combined (e.g., concatenated). In some examples, if multiple different chunks 447 generate an identical question 449, each chunk that generated the question may be considered a positive pair with the question. For example, a single question 449 may be included in a positive pair with a first chunk 447 while simultaneously being included in a positive pair with a second chunk 447 different from the first chunk. In some aspects, a chunk 447 and any question 449 not generated from the chunk 447 may be considered a negative pair. In some cases, the document adapted embedding model 415 may generate embeddings for the chunks 447 and the question adapted embedding model 435 may generate embeddings for the questions 449. In some cases, a combined contrastive learning process may be applied to the document adapted embedding model 415 and the question adapted embedding model 435 using the questions 449 and chunks 447. As shown in FIG. 4C, a similarity function 445 (e.g., cosine similarity) may be utilized during the training process for training the document adapted embedding model 415 and the question adapted embedding model 435.

In some examples, by separately embedding chunks 447 and questions 449, structural limitations that may be present when using a single adapter (e.g., QA adapted embedding model 315 of FIG. 3A through FIG. 3C) can be avoided. For example, the document adapter 410 and the question adapter 424 may represent different functions operating on their inputs. For example, a first function ƒ₁(x) may represent the document adapter 410 and a second function ƒ₂(x) may represent the question adapter 424. In one illustrative example, a chunk x₀ and a question x₁ may be included in a positive pair. In some examples, due to the functions ƒ₁(x), ƒ₂(x) being different, it is possible for ƒ₁(x₀)=ƒ₂(x₁)=y₀ such that two different inputs may produce an identical output without losing the ability to distinguish between the two inputs.

FIG. 6C is a block diagram illustrating an example contrastive learning configuration 640 that may be utilized for contrastive training of the document adapted embedding model 415 of FIG. 4A and the question adapted embedding model 435 of FIG. 4B. In the example of FIG. 6C, a first chunk 642 (e.g., chunks 447 of FIG. 4C) may be used to generate a first question 644 (e.g., questions 449 of FIG. 4C). In some cases, the first question 644 may be generated from the first chunk 642 by an LLM (e.g., GPT, Mistral), human input, and/or any combination thereof. In some cases, a second chunk 652 may be used to generate a second question 654. In some implementations, a chunk and the associated question generated from the chunk may be treated as a positive pair (as indicated by a solid line in FIG. 6A). Accordingly, the first chunk 642 and the first question 644 may be considered a first positive pair 643. Similarly, the second chunk 612 and the second question 654 may be considered a second positive pair 653.

In contrast to the contrastive learning configuration 600 of FIG. 6A, the contrastive learning configuration 640 of FIG. 6C does not treat a chunk and any question not generated from that chunk to be a negative pair. Instead, the contrastive learning configuration 640 of FIG. 6C treats each individual chunk as a negative pair with any other chunk. For example, first chunk 642 may be considered a negative pair (as indicated by dashed lines in FIG. 6C) with second chunk 652. Similarly, the contrastive learning configuration 640 of FIG. 6C treats each individual question as a negative pair with any other question. As another example, first question 644 may be considered a negative pair (as indicated by dashed lines in FIG. 6C) with second question 654. In some cases, the contrastive learning configuration 640 of FIG. 6C can result in negative pairs occurring only between embeddings provided by a particular adapter (e.g., document adapter 410 of FIG. 4A, question adapter 424 of FIG. 4B). For example, the chunks that appear in negative pairs may all be embedded by a document adapter (e.g., document adapter 410 of FIG. 4A). Similarly, the questions that appear in negative pairs may all be embedded by a question adapter (e.g., question adapter 424 of FIG. 4B).

Returning to FIG. 4C, a loss function for the combined training of the document adapted embedding model 415 and the question adapted embedding model 435 is shown in Equation (4) below:

$${λ}_{1} \times {L}_{{CL}_{Q}} ( Q ) + ( 1 - {λ}_{1} ) \times {L}_{{CL}_{C}} ( C ) \qquad ( 4 )$$

Where L_{CL}_{_{Q}}(Q) is a contrastive loss term that accounts for the negative pairs between questions, L_{CL}_{_{C}}(c) is a contrastive loss term that accounts for the negative pairs between chunks, and λ₁ is a hyperparameter. In one illustrative example, a value of λ₁=0.9 may be selected for the hyperparameter λ₁.

The contrastive loss term that accounts for the negative pairs between questions is shown in Equation (5) below:

$${L}_{{CL}_{Q}} = - {\sum }_{i ∈ I} log \frac{exp ( {q}_{i} * {c}_{i} )}{{\sum }_{a ∈ A ( i )} exp ( {q}_{i} * {q}_{a} )} \qquad ( 5 )$$

Where i is an index representing each positive pair, I is an integer representing the number of positive pairs in the training dataset, * represents a cosine similarity function, qᵢ is a question from the ith positive pair, cᵢ is a chunk from the ith positive pair, a is an index, and qₐ represents the question embeddings in negative pairs with the ith question qᵢ. The terms i∈I and A(i) can have the same meaning illustrated in Equation (2) and Equation (3), respectively.

The contrastive loss term that accounts for the negative pairs between chunks is shown in Equation (6) below:

$${L}_{{CL}_{C}} = - {\sum }_{i ∈ I} log \frac{exp ( {c}_{i} * {q}_{i} )}{{\sum }_{a ∈ A ( i )} exp ( {c}_{i} * {c}_{a} )} \qquad ( 6 )$$

Where i is an index representing each positive pair, I is an integer representing the number of positive pairs in the training dataset, * represents a cosine similarity function, qᵢ is a question from the ith positive pair, cᵢ is a chunk from the ith positive pair, a is an index, and cₐ represents the chunk embeddings in negative pairs with the ith chunk cᵢ.

In some cases, by excluding (e.g., masking) negative pairs with respect to a chunk and any question not generated from that chunk, chunks that share similar content may be capable of having similar embeddings (e.g., as determined by cosine similarity). For example, when the loss function does not include terms that push apart a chunk and a related question not generated by that chunk, the lack of a negative pair between the chunk and the related question increases the likelihood that the resulting embeddings will be similar.

FIG. 5 is a block diagram illustrated an example adapted embedding model configuration 500 that may be utilized for adapting an embedding model (e.g., embedding model 222 of FIG. 2, embedding model 308 of FIG. 3A through FIG. 3C, embedding model 408 of FIG. 4A through FIG. 4C. As illustrated in FIG. 5, pre-trained weights W∈ [symbol] ^{d×d} for an embedding model 502 may be kept statis static while updating parameters of the embedding model 502, where W is a matrix containing the weights, [symbol] is the set of real numbers, and d×d represents a dimension of the matrix. In some cases, an input x 501 with a width d equal to the dimension of the embedding model 502 may be provided to the embedding model 502 and to LoRa layers of an adapter 504. As illustrated in FIG. 5, the LoRA layers may represented parameters in a low-rank representation utilizing matrix A and matrix B having a rank r, where r is an integer. In some cases, each layer of the embedding model 502 may have a corresponding LoRA layer of the adapter 504. In some cases, when the matrices A and B for each LoRA are multiplied together, the resulting matrix can have a same number and dimensionality of parameters as the 502. In some cases, by representing the parameters of the adapter 504 using low rank matrices, the amount of data stored in memory during training of the adapter 504 may be reduced. In some cases, an adapted embedding model 515 can be generated by adding together the pre-trained weights of the embedding model 502 with the parameters of the adapter 504 after expansion of the matrices A and B from the LoRA layers. As illustrated in FIG. 5, a single output h 503 can be generated by the adapted embedding model 515 based on the input x 501.

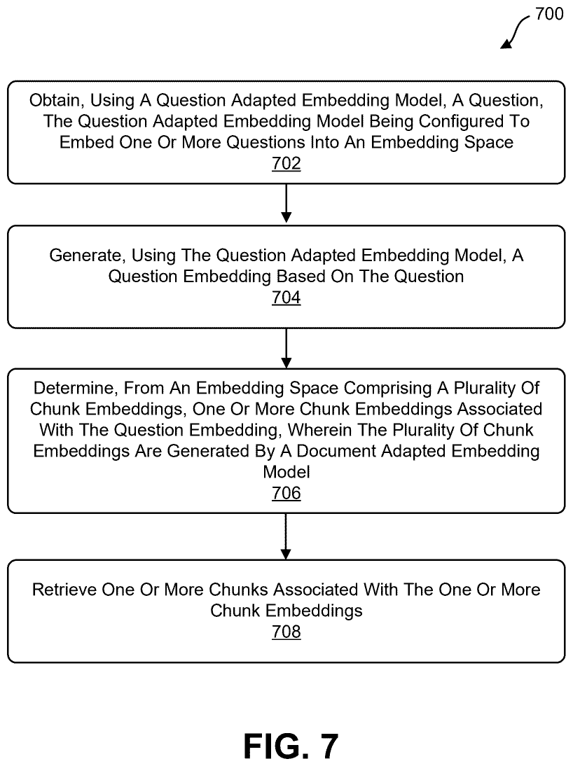

FIG. 7 is a flow diagram illustrating an example of a process 700 of coordinating multi-user experiences. The process 700 and/or other process described herein can be performed by a computing device (or apparatus) or a component (e.g., a chipset, codec, etc.) of the computing device. The computing device may be an extended reality (XR) device (e.g., a virtual reality (VR) device or augmented reality (AR) device), a mobile device (e.g., a mobile phone), a network-connected wearable such as a watch, a vehicle or component or system of a vehicle, or other type of computing device. In one example, the process 700 and/or other process described herein can be performed by RAG system 200 of FIG. 2. In another example, one or more of the processes can be performed by the computing system 1000 shown in FIG. 10. For instance, a computing device with the computing system 1000 shown in FIG. 10 can include the components of the RAG system 200 and can implement the operations of the process 700 of FIG. 7 and/or other process described herein.

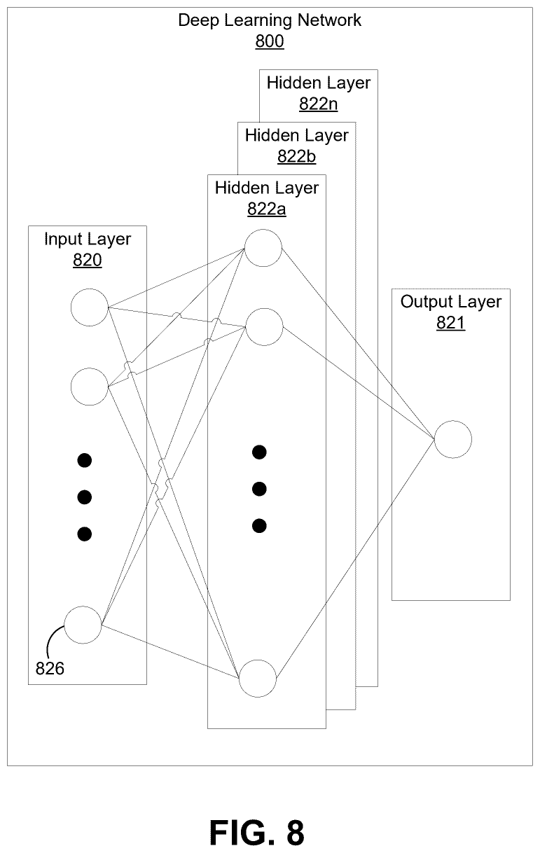

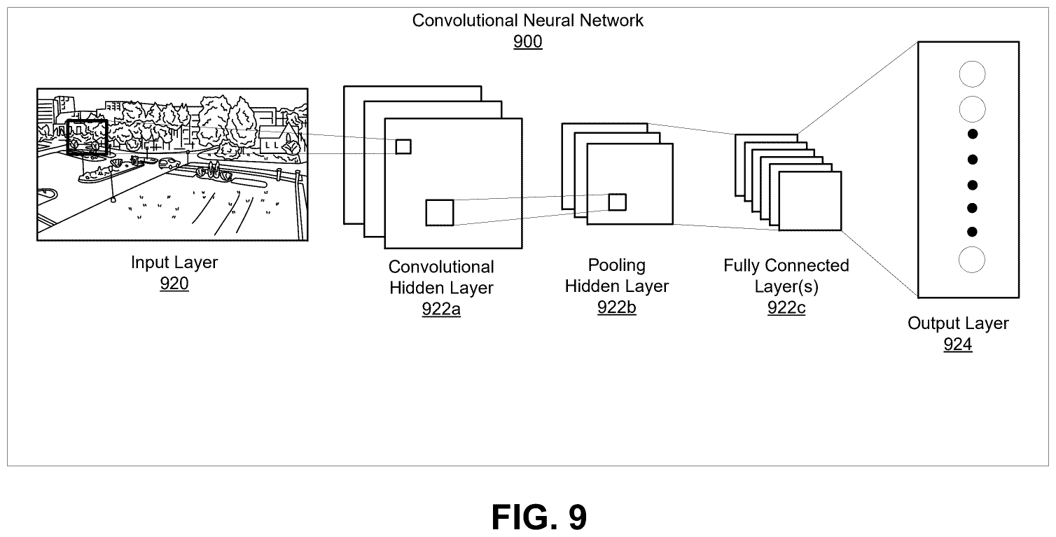

The operations of the process 700 may be implemented as software components that are executed and run on one or more processors (e.g., the processor 1010 of FIG. 10, a processor such as a DSP, GPU, NPU, etc. configured to execute a machine learning model or algorithm, such as the deep learning network 800 of FIG. 8 or the CNN 900 of FIG. 9, or other processor(s)). Further, the transmission and reception of signals by the computing device in the process 700 may be enabled, for example, by one or more antennas, one or more transceivers (e.g., wireless transceiver(s)), and/or other communication components of the computing device (e.g., the communications interface 1040 of FIG. 10).

At block 702, the computing device (or component thereof) can obtain, using a question adapted embedding model (e.g., question adapted embedding model 435 of FIG. 4B), a question (e.g., query 421 of FIG. 4B), the question adapted embedding model being configured to embed one or more questions into an embedding space (e.g., embedding space 426 of FIG. 4B). In some implementations, the question adapted embedding model includes a base embedding model (e.g., embedding model 408 of FIG. 4A and FIG. 4B) and a question adapter model (e.g., question adapter 424 of FIG. 4B).

At block 704, the computing device (or component thereof) can generate, using the question adapted embedding model, a question embedding (e.g., embedding 423 of FIG. 4B) based on the question.

At block 706, the computing device (or component thereof) can determine, from an embedding space including a plurality of chunk embeddings, one or more chunk embeddings associated with the question embedding (e.g., top-K chunks 425 of FIG. 4B). In some examples, the plurality of chunk embeddings are generated by a document adapted embedding mode (e.g., document adapted embedding model 415 of FIG. 4A). In some cases, the document adapted embedding model includes the base embedding model (e.g., embedding model 408 of FIG. 4A and FIG. 4B) and a document adapter model (e.g., document adapter 410 of FIG. 4A). In some implementations, determining, from the embedding space including the plurality of chunk embeddings, the one or more chunk embeddings associated with the question embedding includes determining a similarity between the question embedding and the one or more chunk embeddings. In some aspects, determining the similarity between the question embedding and the one or more chunk embeddings associated with the question embedding includes determining a respective cosine similarity between the question embedding and each respective chunk embedding of the one or more chunk embeddings.

At block 708, the computing device (or component thereof) can retrieve one or more chunks associated (e.g., top-K chunks 425 of FIG. 4B) with the one or more chunk embeddings. In some cases, retrieving the one or more chunks associated with the one or more chunk embeddings includes retrieving the one or more chunks based on respective indices of the one or more chunks.

In some aspects, the question adapter model includes a first plurality of weights and the document adapter model includes a second plurality of weights, the first plurality of weights being different from the second plurality of weights. In some examples, the second plurality of weights is generated based on a plurality of training chunks (e.g., chunks 447 of FIG. 4C) associated with a training data set and the first plurality of weights is generated based on a plurality of questions (e.g., questions 449 of FIG. 4C) generated based on the plurality of training chunks. In some implementations, at least one of the question adapter model or the document adapter model includes a LoRA model.

In some implementations, the computing device (or component thereof) can modify the question, based on the one or more chunks associated with the question, to obtain a modified question and output modified question.

In some examples, the processes described herein (e.g., process 700 and/or other process described herein) may be performed by a computing device or apparatus. In one example, one or more of the processes can be performed by the RAG system 200 of FIG. 2. In another example, one or more of the processes can be performed by the computing system 1000 shown in FIG. 10. For instance, a computing device with the computing system 1000 shown in FIG. 10 can include the components of the RAG system 200 and can implement the operations of the process 700 of FIG. 7 and/or other process described herein.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the process 700 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted above, various aspects of the present disclosure can use machine learning models or systems. FIG. 8 is an illustrative example of a deep learning neural network 800 that can be used to implement the machine learning based feature extraction and/or activity recognition (or classification) described above. An input layer 820 includes input data. In one illustrative example, the input layer 820 can include data representing the pixels of an input video frame. The neural network 800 includes multiple hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The neural network 800 further includes an output layer 821 that provides an output resulting from the processing performed by the hidden layers 822a, 822b, through 822n. In one illustrative example, the output layer 821 can provide a classification for an object in an input video frame. The classification can include a class identifying the type of activity (e.g., looking up, looking down, closing eyes, yawning, etc.).

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes (e.g., node 826) in the neural network 800 are shown as having multiple output lines, a node has a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822a, 822b, through 822n in order to provide the output through the output layer 821. In an example in which the neural network 800 is used to identify activities being performed by a driver in frames, the neural network 800 can be trained using training data that includes both frames and labels, as described above. For instance, training frames can be input into the network, with each training frame having a label indicating the features in the frames (for the feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 800 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 800 is trained well enough so that the weights of the layers are accurately tuned.

For the example of identifying objects in frames, the forward pass can include passing a training frame through the neural network 800. The weights are initially randomized before the neural network 800 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 800, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 800 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 800 can perform a backward pass by determining which inputs (weights) most contributed to the loss of the network, and can adjust the weights so that the loss decreases and is eventually minimized. A derivative of the loss with respect to the weights (denoted as dLldW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 800 can include any other deep network other than a CNN, such as an autoencoder, a deep belief nets (DBNs), a Recurrent Neural Networks (RNNs), among others.

FIG. 8 is an illustrative example of a convolutional neural network (CNN) 900. The input layer 920 of the CNN 900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 922a, an optional non-linear activation layer, a pooling hidden layer 922b, and fully connected hidden layers 922c to get an output at the output layer 924. While only one of each hidden layer is shown in FIG. 8, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 is the convolutional hidden layer 922a. The convolutional hidden layer 922a analyzes the image data of the input layer 920. Each node of the convolutional hidden layer 922a is connected to a region of nodes (pixels) of the input image called a receptive field. The convolutional hidden layer 922a can be considered as one or more filters (each filter corresponding to a different activation or feature map), with each convolutional iteration of a filter being a node or neuron of the convolutional hidden layer 922a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 922a. Each connection between a node and a receptive field for that node learns a weight and, in some cases, an overall bias such that each node learns to analyze its particular local receptive field in the input image. Each node of the hidden layer 922a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 922a is due to each node of the convolutional layer being applied to its corresponding receptive field. For example, a filter of the convolutional hidden layer 922a can begin in the top-left corner of the input image array and can convolve around the input image. As noted above, each convolutional iteration of the filter can be considered a node or neuron of the convolutional hidden layer 922a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 922a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 922a.

The mapping from the input layer to the convolutional hidden layer 922a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 922a can include several activation maps in order to identify multiple features in an image. The example shown in FIG. 8 includes three activation maps. Using three activation maps, the convolutional hidden layer 922a can detect three different kinds of features, with each feature being detectable across the entire image.

In some examples, a non-linear hidden layer can be applied after the convolutional hidden layer 922a. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 900 without affecting the receptive fields of the convolutional hidden layer 922a.

The pooling hidden layer 922b can be applied after the convolutional hidden layer 922a (and after the non-linear hidden layer when used). The pooling hidden layer 922b is used to simplify the information in the output from the convolutional hidden layer 922a. For example, the pooling hidden layer 922b can take each activation map output from the convolutional hidden layer 922a and generates a condensed activation map (or feature map) using a pooling function. Max-pooling is one example of a function performed by a pooling hidden layer. Other forms of pooling functions be used by the pooling hidden layer 922b, such as average pooling, L2-norm pooling, or other suitable pooling functions. A pooling function (e.g., a max-pooling filter, an L2-norm filter, or other suitable pooling filter) is applied to each activation map included in the convolutional hidden layer 922a. In the example shown in FIG. 8, three pooling filters are used for the three activation maps in the convolutional hidden layer 922a.

In some examples, max-pooling can be used by applying a max-pooling filter (e.g., having a size of 2×2) with a stride (e.g., equal to a dimension of the filter, such as a stride of 2) to an activation map output from the convolutional hidden layer 922a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 922a having a dimension of 24×24 nodes, the output from the pooling hidden layer 922b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 922b to every one of the output nodes in the output layer 924. Using the example above, the input layer includes 28×28 nodes encoding the pixel intensities of the input image, the convolutional hidden layer 922a includes 3×24×24 hidden feature nodes based on application of a 5×5 local receptive field (for the filters) to three activation maps, and the pooling hidden layer 922b includes a layer of 3×12×12 hidden feature nodes based on application of max-pooling filter to 2×2 regions across each of the three feature maps. Extending this example, the output layer 924 can include ten output nodes. In such an example, every node of the 3×12×12 pooling hidden layer 922b is connected to every node of the output layer 924.

The fully connected layer 922c can obtain the output of the previous pooling hidden layer 922b (which should represent the activation maps of high-level features) and determines the features that most correlate to a particular class. For example, the fully connected layer 922c layer can determine the high-level features that most strongly correlate to a particular class, and can include weights (nodes) for the high-level features. A product can be computed between the weights of the fully connected layer 922c and the pooling hidden layer 922b to obtain probabilities for the different classes. For example, if the CNN 900 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 924 can include an M-dimensional vector (in the prior example, M=10). M indicates the number of classes that the CNN 900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for retrieving data, the apparatus comprising: at least one memory; and at least one processor coupled to the at least one memory and configured to: obtain, using a question adapted embedding model, a question, the question adapted embedding model being configured to embed one or more questions into an embedding space; generate, using the question adapted embedding model, a question embedding based on the question; determine, from an embedding space comprising a plurality of chunk embeddings, one or more chunk embeddings associated with the question embedding, wherein the plurality of chunk embeddings are generated by a document adapted embedding model; and retrieve one or more chunks associated with the one or more chunk embeddings.

Aspect 2. The apparatus of Aspect 1, wherein the question adapted embedding model comprises a base embedding model and a question adapter model.

Aspect 3. The apparatus of Aspect 2, wherein the document adapted embedding model comprises the base embedding model and a document adapter model.

Aspect 4. The apparatus of Aspect 3, wherein the question adapter model comprises a first plurality of weights and the document adapter model comprises a second plurality of weights, the first plurality of weights being different from the second plurality of weights.

Aspect 5. The apparatus of Aspect 4, wherein: the second plurality of weights is generated based on a plurality of training chunks associated with a training data set; and the first plurality of weights is generated based on a plurality of questions generated based on the plurality of training chunks.

Aspect 6. The apparatus of any one of Aspects 3 to 5, wherein at least one of the question adapter model or the document adapter model comprises a low-rank adaptation (LoRA) model.

Aspect 7. The apparatus of any one of Aspects 1 to 6, wherein to determine, from an embedding space comprising a plurality of chunk embeddings, the one or more chunk embeddings associated with the question embedding, the at least one processor is configured to determine a similarity between the question embedding and the one or more chunk embeddings.

Aspect 8. The apparatus of Aspect 7, wherein, to determine the similarity between the question embedding and the one or more chunk embeddings associated with the question embedding, the at least one processor is configured to determine a respective cosine similarity between the question embedding and each respective chunk embedding of the one or more chunk embeddings.

Aspect 9. The apparatus of any one of Aspects 7 or 8, wherein, to retrieve the one or more chunks associated with the one or more chunk embeddings, the at least one processor is configured to retrieve the one or more chunks based on respective indices of the one or more chunks.

Aspect 10. The apparatus of any one of Aspects 1 to 9, wherein the at least one processor is further configured to: modify the question, based on the one or more chunks associated with the question, to obtain a modified question; and output the modified question.

Aspect 11. A method for retrieving data, the method comprising: obtaining, using a question adapted embedding model, a question, the question adapted embedding model being configured to embed one or more questions into an embedding space; generating, using the question adapted embedding model, a question embedding based on the question; determining, from an embedding space comprising a plurality of chunk embeddings, one or more chunk embeddings associated with the question embedding, wherein the plurality of chunk embeddings are generated by a document adapted embedding model; and retrieving one or more chunks associated with the one or more chunk embeddings.

Aspect 12. The method of Aspect 11, wherein the question adapted embedding model comprises a base embedding model and a question adapter model.

Aspect 13. The method of Aspect 12, wherein the document adapted embedding model comprises the base embedding model and a document adapter model.

Aspect 14. The method of Aspect 13, wherein the question adapter model comprises a first plurality of weights and the document adapter model comprises a second plurality of weights, the first plurality of weights being different from the second plurality of weights.

Aspect 15. The method of Aspect 14, wherein: the second plurality of weights is generated based on a plurality of training chunks associated with a training data set; and the first plurality of weights is generated based on a plurality of questions generated based on the plurality of training chunks.

Aspect 16. The method of any one of Aspects 13 to 15, wherein at least one of the question adapter model or the document adapter model comprises a LoRA model.

Aspect 17. The method of any one of Aspects 11 to 16, wherein determining, from the embedding space comprising the plurality of chunk embeddings, the one or more chunk embeddings associated with the question embedding comprises determining a similarity between the question embedding and the one or more chunk embeddings.

Aspect 18. The method of Aspect 17, wherein determining the similarity between the question embedding and the one or more chunk embeddings associated with the question embedding comprises determining a respective cosine similarity between the question embedding and each respective chunk embedding of the one or more chunk embeddings.

Aspect 19. The method of any one of Aspects 17 or 18, wherein retrieving the one or more chunks associated with the one or more chunk embeddings comprises retrieving the one or more chunks based on respective indices of the one or more chunks.

Aspect 20. The method of any one of Aspects 11 to 19, further comprising: modifying the question, based on the one or more chunks associated with the question, to obtain a modified question; and outputting the modified question.

Aspect 21. A method of adapting a machine learning (ML) model, the method comprising: obtaining a plurality of chunks comprising a first chunk and a second chunk; generating, based on the first chunk, a first question associated with the first chunk; generating, based on the second chunk, a second question associated with the second chunk, wherein a plurality of questions comprises the first question and the second question; generating, by a chunk adapted embedding model, a first chunk embedding associated with the first chunk and a second chunk embedding associated with the second chunk; generating, by a question adapted embedding model, a first question embedding associated with the first question and a second question embedding associated with the second question, wherein the question adapted embedding model is different from the chunk adapted embedding model; and minimizing a contrastive loss associated with the first chunk, the second chunk, the first question, and the second question.

Aspect 22. The method of Aspect 21, wherein: the first chunk and the first question comprise a first positive pair; and the second chunk and the second question comprise a second positive pair.

Aspect 23. The method of Aspect 22, wherein minimizing the contrastive loss associated with the first chunk, the second chunk, the first question, and the second question comprises: determining a first contrastive loss between the first chunk and the second chunk; determining a second contrastive loss between the first question and the second question; determining a third contrastive loss associated with the first positive pair; and determining a fourth contrastive loss associated with the second positive pair.

Aspect 24. An apparatus for adapting a machine learning (ML) model, the apparatus comprising: at least one memory; and at least one processor coupled to the at least one memory and configured to: obtain a plurality of chunks comprising a first chunk and a second chunk; generate, based on the first chunk, a first question associated with the first chunk; generate, based on the second chunk, a second question associated with the second chunk, wherein a plurality of questions comprises the first question and the second question; generate, by a chunk adapted embedding model, a first chunk embedding associated with the first chunk and a second chunk embedding associated with the second chunk; generate, by a question adapted embedding model, a first question embedding associated with the first question and a second question embedding associated with the second question, wherein the question adapted embedding model is different from the chunk adapted embedding model; and minimize a contrastive loss associated with the first chunk, the second chunk, the first question, and the second question.

Aspect 25. The apparatus of Aspect 24, wherein: the first chunk and the first question comprise a first positive pair; and the second chunk and the second question comprise a second positive pair.

Aspect 26. The apparatus of Aspect 25, wherein, to minimize the contrastive loss associated with the first chunk, the second chunk, the first question, and the second question, the at least one processor is configured to: determine a first contrastive loss between the first chunk and the second chunk; determine a second contrastive loss between the first question and the second question; determine a third contrastive loss associated with the first positive pair; and determine a fourth contrastive loss associated with the second positive pair.

Aspect 27: A non-transitory computer-readable storage medium having stored thereon instructions which, when executed by one or more processors, cause the one or more processors to perform any of the operations of aspects 11 to 20.

Aspect 28: An apparatus comprising means for performing any of the operations of aspects 11 to 20.

Aspect 29: A non-transitory computer-readable storage medium having stored thereon instructions which, when executed by one or more processors, cause the one or more processors to perform any of the operations of aspects 21 to 23.

Aspect 30: An apparatus comprising means for performing any of the operations of aspects 21 to 23.

Aspect 31: A method comprising operations according to any of Aspects 11 to 20 and any of Aspects 21 to 23.

Aspect 32: An apparatus for retrieving data. The apparatus includes a memory (e.g., implemented in circuitry) and one or more processors (e.g., one processor or multiple processors) coupled to the memory. The one or more processors are configured to perform operations according to any of Aspects 11 to 20 and any of Aspects 21 to 23.

What is claimed is:

1. An apparatus for retrieving data, the apparatus comprising:
at least one memory; and
at least one processor coupled to the at least one memory and configured to:
obtain, using a question adapted embedding model, a question, the question adapted embedding model being configured to embed one or more questions into an embedding space;
generate, using the question adapted embedding model, a question embedding based on the question;
determine, from an embedding space comprising a plurality of chunk embeddings, one or more chunk embeddings associated with the question embedding, wherein the plurality of chunk embeddings are generated by a document adapted embedding model; and
retrieve one or more chunks associated with the one or more chunk embeddings.

2. The apparatus of claim 1, wherein the question adapted embedding model comprises a base embedding model and a question adapter model.

3. The apparatus of claim 2, wherein the document adapted embedding model comprises the base embedding model and a document adapter model.

4. The apparatus of claim 3, wherein the question adapter model comprises a first plurality of weights and the document adapter model comprises a second plurality of weights, the first plurality of weights being different from the second plurality of weights.

5. The apparatus of claim 4, wherein:
the second plurality of weights is generated based on a plurality of training chunks associated with a training data set; and
the first plurality of weights is generated based on a plurality of questions generated based on the plurality of training chunks.

6. The apparatus of claim 3, wherein at least one of the question adapter model or the document adapter model comprises a low-rank adaptation (LoRA) model.

7. The apparatus of claim 1, wherein to determine, from an embedding space comprising a plurality of chunk embeddings, the one or more chunk embeddings associated with the question embedding, the at least one processor is configured to determine a similarity between the question embedding and the one or more chunk embeddings.

8. The apparatus of claim 7, wherein, to determine the similarity between the question embedding and the one or more chunk embeddings associated with the question embedding, the at least one processor is configured to determine a respective cosine similarity between the question embedding and each respective chunk embedding of the one or more chunk embeddings.

9. The apparatus of claim 7, wherein, to retrieve the one or more chunks associated with the one or more chunk embeddings, the at least one processor is configured to retrieve the one or more chunks based on respective indices of the one or more chunks.

10. The apparatus of claim 1, wherein the at least one processor is further configured to:
modify the question, based on the one or more chunks associated with the question, to obtain a modified question; and
output the modified question.

11. A method for retrieving data, the method comprising:
obtaining, using a question adapted embedding model, a question, the question adapted embedding model being configured to embed one or more questions into an embedding space;
generating, using the question adapted embedding model, a question embedding based on the question;
determining, from an embedding space comprising a plurality of chunk embeddings, one or more chunk embeddings associated with the question embedding, wherein the plurality of chunk embeddings are generated by a document adapted embedding model; and
retrieving one or more chunks associated with the one or more chunk embeddings.

12. The method of claim 11, wherein the question adapted embedding model comprises a base embedding model and a question adapter model.

13. The method of claim 12, wherein the document adapted embedding model comprises the base embedding model and a document adapter model.

14. The method of claim 13, wherein the question adapter model comprises a first plurality of weights and the document adapter model comprises a second plurality of weights, the first plurality of weights being different from the second plurality of weights.

15. The method of claim 14, wherein:
the second plurality of weights is generated based on a plurality of training chunks associated with a training data set; and
the first plurality of weights is generated based on a plurality of questions generated based on the plurality of training chunks.

16. The method of claim 13, wherein at least one of the question adapter model or the document adapter model comprises a LoRA model.

17. The method of claim 11, wherein determining, from the embedding space comprising the plurality of chunk embeddings, the one or more chunk embeddings associated with the question embedding comprises determining a similarity between the question embedding and the one or more chunk embeddings.

18. The method of claim 17, wherein determining the similarity between the question embedding and the one or more chunk embeddings associated with the question embedding comprises determining a respective cosine similarity between the question embedding and each respective chunk embedding of the one or more chunk embeddings.

19. The method of claim 17, wherein retrieving the one or more chunks associated with the one or more chunk embeddings comprises retrieving the one or more chunks based on respective indices of the one or more chunks.

20. The method of claim 11, further comprising:
modifying the question, based on the one or more chunks associated with the question, to obtain a modified question; and
outputting the modified question.
